(19) United States
(12) Patent Application Publication
(10) Pub. No.: US 2008/0306774 A1
(43) Pub. Date: Dec. 11, 2008

(54) Methods and apparatus for digital audio, video, and data player and recorder and business method of managing medical information on a branded data storage device

(76) Inventors: Andrew George, Beverly Hills, CA (US); Josh Lieber, Irvine, CA (US)

Correspondence Address: JAMES D. PETRUZZI, 4900 WOODWAY SUITE 745, HOUSTON, TX, 77056, US

(21) Appl. No.: 12/156,850

(22) Filed: Jun. 5, 2008

Related U.S. Application Data
(60) Provisional application No. 60/933,630, filed on Jun. 7, 2007.

(51) Int. Cl. G06Q 50/00; G06Q 10/00; H04B 1/034; G05B 19/00; H04L 9/32

(52) U.S. Cl. 705/3; 705/2; 455/95; 340/5.82; 340/5.85

(57) ABSTRACT

A credit card sized digital storage device and data system and method of marketing same pertaining to health care information, a memory and processor for processing digital data, an output on the card for converting and transmitting the digital data for video output, a set of touch sensitive controls on the planar surface of the card, a modifiable planar surface for placement of graphics, and electrical access to the memory and processor for upload and download of the digital content. A preferred embodiment includes memory storage of a patient's pertinent medical information for retrieval, addition and use by medical personnel. A preferred embodiment includes wireless transmitter or a USB connector for physical connection to a computing device. The device may also be used for branding and facilitating interrelationships between patient, medical providers and others involved in health care.

### CROSS REFERENCE TO RELATED APPLICATIONS

This application is based on provisional application Ser. No. 60/933,630, filed on Jun. 7, 2007 and is incorporated by reference as if fully set forth herein.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of medical data and records and more specifically to methods and apparatus for digital audio, video, and data player and recorder and business method of managing medical information on a branded data storage device.

The move by health care providers from paper based health care information systems to electronic systems requires safeguards for ensuring privacy and security of patient information gathered as part of providing health care. In addition patients and health care providers need access to records from other health care providers to provide synergistic health care and prevent medical errors.

In the United States alone, around 100,000 people die every year in hospitals due to preventable errors. 1 in every 5 of these fatal errors results from a lack of immediate access to patient health care information. Studies estimate that medical errors kill more Americans each year than breast cancer, AIDS or car accidents. Around 75% of Americans believe electronic medical records (EMRs) can improve the quality of their health care, lower their medical costs and would enable them to make better decisions about their health and overall well-being.

Without EMRs, physicians, hospitals and pharmacies cannot share patient information that is necessary for timely, patient-centered and efficient care. As of 2006, fewer than 10% of American hospitals—and only 16% of primary care physicians—had implemented health information technology. The health care industry spends only 2% of gross revenues on technology, as compared to most other industries that spend upwards of 10% on technology.

There is a strong need for technology that can protect the confidentiality of individual EMRs, since approximately 150 people (from doctors, technicians, billing clerks, etc.) have access to at least part of a patient's records during a hospitalization and afterwards, an astonishing 600,000 people in the health care industry will have access to those same records. Limitations in software, hardware and networking technologies have made EMRs difficult to affordably implement in small, budget-conscious health care organizations. The US Government recently called for the majority of Americans to have EMRs by the year 2014—a National Coordinator for health information technology has been established to realize this goal.

Smart cards and similar devices have the potential to provide easier information access management. Smart cards and similar devices have some limitations in that medical records cannot be adequately safeguarded and privacy not assured. With the present invention, there is shown an integrated data storage system and hand held data card for sharing and retrieval of medical information wirelessly, on the internet, or through other network, to share and use data between the patient and health care providers.

### BRIEF SUMMARY OF THE INVENTION

The primary object of the invention is to provide an improved data and video storage device for medical information of a user.

Another object of the invention is to provide a digital data storage device that is not subject to piracy and is encrypted and secure.

Another object of the invention is to provide a marketing and branding concept for medical providers and suppliers.

A further object of the invention is to provide a snapshot of a patient's critical medical information.

Yet another object of the invention is to make use of various microelectronics to deliver digital content in a convenient and innovative credit card sized package.

Still yet another object of the invention is to provide encrypted storage of medical information of a user and biometric security to allow medical personnel access to such information in an emergency when the patient is unable to provide a password or other standard security challenge and response.

Still yet another object of the invention is to provide a business method for marketing and selling branded data cards containing pertinent patient health care information through the health care system in a secure and network oriented system.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed credit card sized digital storage device having a memory and processor for processing digital data pertaining to a user's health, an output on the card for converting and transmitting the digital data for video output, a set of touch sensitive controls on the planar surface of the card, a modifiable planar surface for placement of graphics, and a mode for access to the memory and processor for upload and download of the digital content

In accordance with a preferred embodiment of the invention, there is disclosed a credit card sized digital storage device having a memory and processor for processing digital data, an output on the card for converting and transmitting the digital data for video output, a set of touch sensitive controls on the planar surface of the card, a modifiable planar surface for placement of graphics, and a wireless transmitter for electronic exchange of data with a computing device.

In accordance with a preferred embodiment of the invention, there is disclosed a credit card sized digital storage device having a digital storage device, a memory and processor for processing digital data pertinent to a user's health care, an output on the card for converting and transmitting the digital data for audio and video output, a set of touch sensitive controls on the planar surface of the card, a modifiable planar surface for placement of graphics, and a wired data connector such as a USB, high speed serial bus, or similar physical connection for electrical access to the memory and processor for upload and download of the digital content, and a wireless radio transmitter for electronic exchange of data with a computing device.

In accordance with a preferred embodiment of the invention, there is disclosed a business method for managing medical information on a branded data storage device comprising the steps of placing medical data content in data memory on a credit card sized handheld carrier capable of outputting content in an audible and visual format, compiling medical content for a particular user for placement in the memory, branding the planar surface of the carrier with service provider related graphics, and securing access to the digital content to prevent erasure of the content.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention with data port connection in extended position.

FIG. 2 is a perspective view of the invention with exemplary audio output jack and headphones.

FIG. 3 is a partial cutaway view of the invention with back planar surface removed displaying internal electronic components.

FIG. 4 shows several plan views of a side of the invention as branded data card as affinity, membership or identification cards.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

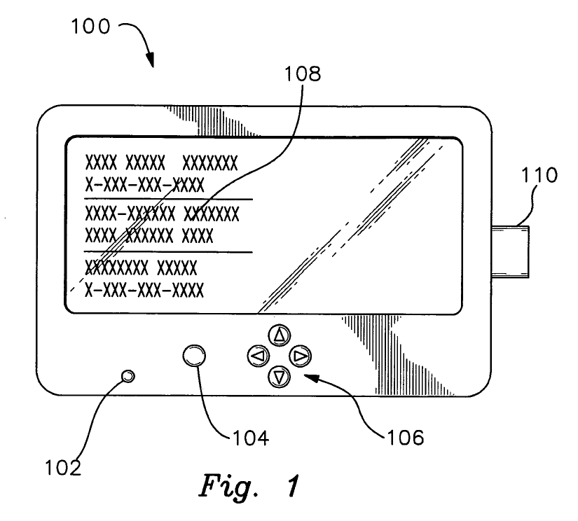

FIG. 1 shows an exemplary credit card sized device 100 for display of medical and other information. An emergency button 102 and membrane covered enter button 104 and membrane covered navigation buttons 106 allow easy access to the digital data stored on the device 100. The device also features a screen 108 which can be an LCD, plasma or other technology for display of data. Screen 108 may be touch sensitive for an alternative data entry method and may also double as a biometric reader allowing the user to access the data by placing a finger on the reader. This biometric feature also allows medical personnel full access to the data in instances where a patient is unconscious and in need of emergency treatment. Medical personnel can place the patient's finger onto the card to access the data in lieu of the patient providing their secure access password. In an alternative preferred embodiment the biometric device could be required for access in concert with a secure access password or medical personnel would be required to provide a password along with the patient's biometric reading. This feature prevents access without the patient's presence and provides additional patient privacy.

The portable, self-reading, self-contained personalized and/or branded ultra-thin, credit-card sized device that contains data including written materials, images (e.g. x-rays), videos (MRI's, CT scans) and audio (doctor's notes) comprises a personal medical record. One's critical personal medical data will exist in a “snapshot” that will include one's name, social security number or other personally unique identifiable number or passcode, blood type, allergies, emergency contact info, existing medical conditions, diagnoses and current medications listed by type and dosage, warnings of drug interactions, flagging of critical lab values, patient-specific personal medical reminders, as well as Advance Health Directive. The “snapshot” menu will be scrollable and operate with 4 directional buttons that facilitate data navigation. The device will have a data connection implanted in its end. Furthermore, the device will be able to communicate and update when connected wirelessly or through a data connection (such as a universal serial bus (USB), high speed serial bus or other wired connection) to a database on any computer that, through the internet, connects to a more extensive, personalized database of one's personal medical information that will be securely accessed and updated by physicians.

FIG. 1 shows a wired data port 110 which can be a USB, high speed serial bus or other physically wired connection for use by the medical service provider and their computing devices. In an alternative preferred embodiment, card 100 can also transfer data with other computing devices by means of a wireless transmitter receiver such as the popular BLUETOOTH® technology. This allows physicians and other medical professionals to connect directly with the device from mobile computing devices that are currently in use in many health care facilities today as well as BLUETOOTH® audio headsets for audio input and output with the device 100.

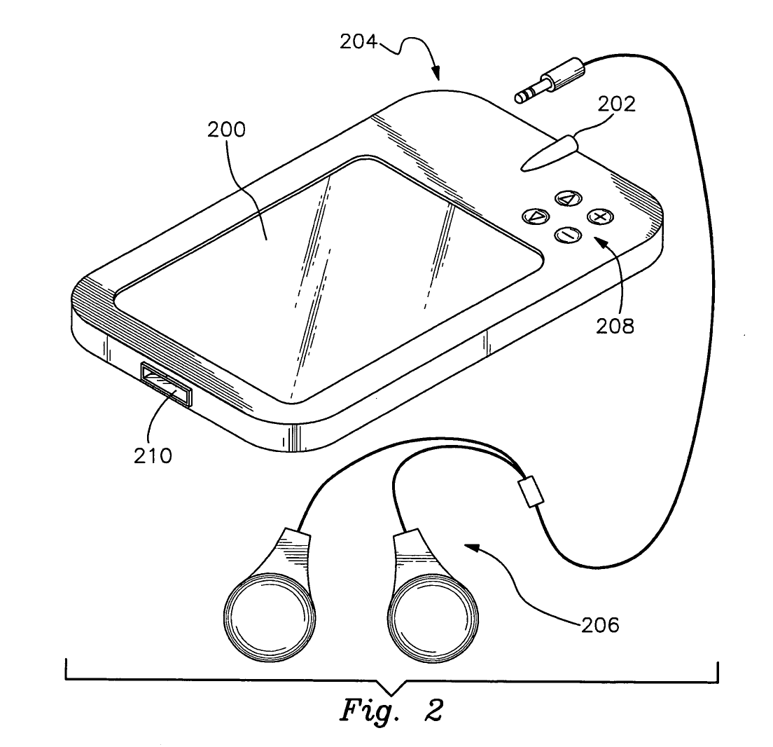

FIG. 2 shows an alternative preferred embodiment wherein the credit card sized device is fitted with a scalable screen 200, an audio input output jack 202, a built in microphone 204, an audio headset 206, membrane navigation and volume control buttons and a wired data port 210 shown here in the retracted position. In certain instances having data sent by audio may be an advantage depending on the data and, in some cases, those with eyesight impairment may use the audio output to receive certain data, alerts, or other medical information or news etc.

In either embodiment, the user has a compact electronic record of one's essential medical data, as well as images (x-rays, etc.) and videos (CT scans, MRI's, etc.). The card can remind those with chronic conditions when to take medications or perform tasks (e.g. antibiotics, insulin injections), and will send daily alerts and relevant articles relating to one's condition. The card will also provide protection to patients from the inefficiency of a fragmented health care system (the average elderly patient has 7+ physicians, most of whom never communicate with each other). By using the card, the use will save money from redundant tests and examinations and will help avoid misdiagnosis and poor communication between physicians and patients.

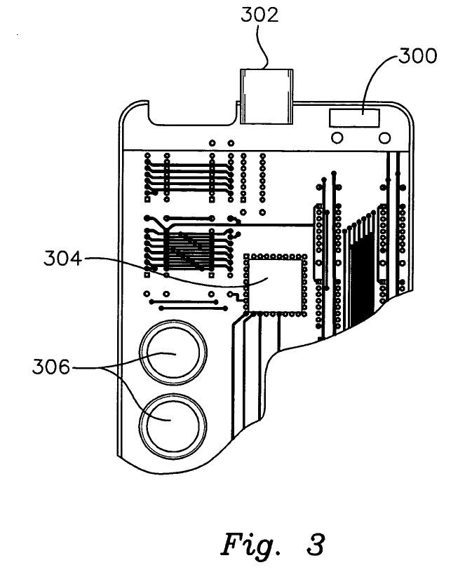

FIG. 3 shows a cutaway view of the internal electronics of the device including a wireless transmitter receiver 300 such as a Bluetooth® technology transmitter receiver for transmitting digital data to other electronic devices, an internal low power adaptable memory 304 card or chip for storage of digital data. In an alternative configuration, the memory 304 chips can be removable. The device can be electrically powered by conventional or rechargeable batteries 306 and can have a pendulum or movement operated recharging mechanism such that an individual's movement throughout the day could keep the device fully charged.

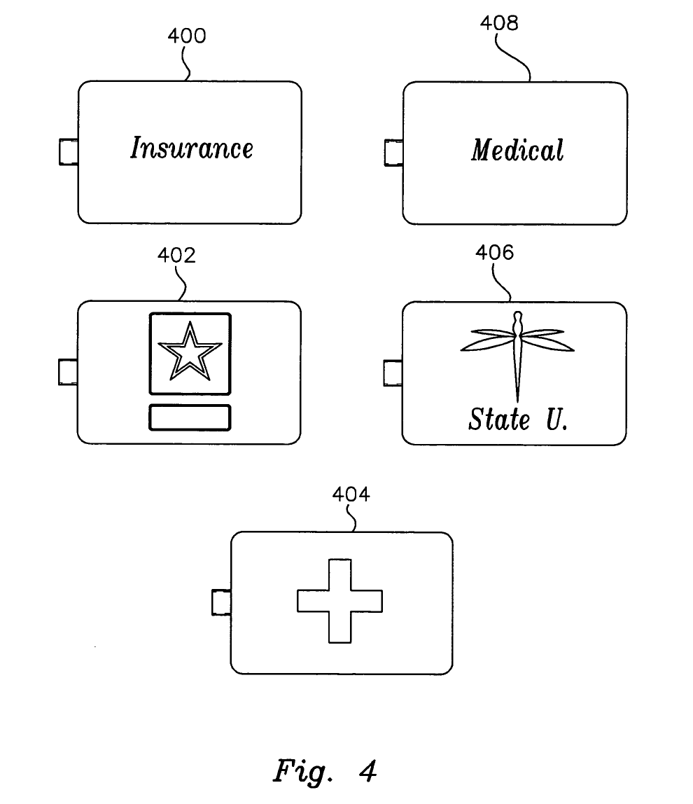

FIG. 4 shows a variety of branded or affinity cards shown here with various graphics embossed on the reverse side planar surface of the credit card device. Shown are exemplary versions of the device as an insurance card 400 bearing the name of the insurance provider or company, a government issued identification card 402, a non governmental organization affinity card 404, a school student id card 406 and a fraternal or special interest group membership card 408. These branding configurations can provide added value and assure better compliance by the patient with actually carrying the card. These branded cards are part of the business methods claimed and comprise another unique aspect of the invention.

A number of other uses for the device are envisioned, including but not limited to playback of entertainment, educational or other audio and video content, audio and video reminders to the patient to comply with medication dosing schedules and entry of compliance complete with date time stamps once dosing is complete. In other embodiments, the provider can enable subscription based features to consumers (e.g., a diabetic who requests daily health upkeep reminders sent directly to his device) and advertising directly on the device, narrowly targeting the consumer (e.g., ads that would be relevant to one's specific condition or illness.)

Another feature of the business method is the capturing of valuable consumer demographic data to be sold to pharmaceutical companies in a way that protects the patient's privacy. A dedicated server and the branded device can be subsidized by pharmaceutical and insurance companies in exchange for this anonymous patient info and additional patient-targeted ads. Incremental services, such as additional customized information for mobile devices and services for doctors (e.g., enhanced customer service, more frequent back-ups, medical reminder services, and aggregated data) may also be employed.

These devices may be effectively distributed and marketed by the most credible source possible: the patient's doctors. Doctors would get this system from the system administrator or card developer at a cost far below what EMR systems have traditionally cost. The system administrator could also offer versions subsidized by pharmaceutical and insurance companies as an option, or doctors could sell the device to their patients as a revenue stream and to help build patient loyalty.

The more of the patient's doctors that use this system, the more value it has for the patient and his doctors. Doctors get a multi-faceted, low-cost, self-contained system that's automatically backed up, accessible anywhere and serves as a robust value add for their patients. The patient gets a device full of pertinent info that is predominantly and automatically populated by their doctors.

By managing the complete system, the administrator of the card device and integrated data system is in a much better position to provide an optimal experience for all users. This comprehensive approach enables the administrator of the system to be at the leading edge of how information/communications technologies are evolving the doctor/patient relationship. Now, patients will play a much less passive role—the card and data system supports this experience from a patient perspective, and helps doctors better manage it from theirs.

All trends point to a future where electronic medical records will be an integral part of people's lives in the next 5-8 years. This device and system will take advantage of this unprecedented growth prospect by appealing to the earliest adopters and their families:

There are approximately 2.7 million people who serve in the U.S. Military—each will be an ideal candidate to use the system, where the device will serve as a 21st-century dog tag.

There are 70 million Americans over the age of 55 (on average, this age group sees 7+ doctors)—every one of these individuals is a potential customer.

Currently, 135 million Americans have chronic conditions—each is a potential customer.

After the device is available in the US, it can be launched in the EU (where approximately 150 million people have chronic conditions) and after that, additional territories throughout the world.

The device and data system may be introduced in numerous sales channels, including insurance companies, health groups and organizations (e.g., AARP), pharmacies, system administrator website, EMR Websites, PHR websites, corporations, universities, retailers/channel marketers, medical supply companies, governments and national health plans, or any interaction with a point of contact with the health industry.

By creating strategic partnerships, this device and networked system can become the standard in health maintenance. Increasingly, patients are being encouraged by doctors, corporations and insurance companies to manage their health. Even the US government has proposed that all Americans be linked to electronic medical records by 2011. Additionally, physician reimbursement is being tied to adherence to medical guidelines and patient health outcomes. In this current environment, a self-contained, self-readable, low-cost portable electronic medical record will be a necessity. The device and system of the instant invention empowers individuals, families and communities to easily maintain and access a reliable, up-to-date personal medical record. Likewise, it takes personal control of health care to the next level, placing it literally in the hands of the patient.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the claims.

What is claimed is:

1. A credit card sized digital storage device comprising;
a memory and processor for processing digital data pertaining to a user's health;
an output on said card for converting and transmitting said digital data for video output;
a set of touch sensitive controls on the planar surface of said card;
a modifiable planar surface for placement of graphics; and
an access mode to said memory and processor for upload and download of said digital content.

2. A credit card sized digital storage device as claimed in claim 1 wherein said memory
stores patient's pertinent medical information for retrieval and addition and use by medical personnel.

3. A credit card sized digital storage device as claimed in claim 2 wherein said
data connector is a USB connector for physical connection to a computing device.

4. A credit card sized digital storage device as claimed in claim 2 wherein said
data connector is a wireless radio transmitter for electronic exchange of data with a computing device.

5. A credit card sized digital storage device as claimed in claim 2 further comprising
a biometric reader for secure access to patient's medical information when patient is unable to provide password for access.

6. A credit card sized digital storage device as claimed in claim 2 wherein said
graphics placed on said modifiable planar surface function as an identification card.

7. A credit card sized digital storage device as claimed in claim 2 further comprising
an emergency button on said planar surface for access to said medical information by medical personnel.

8. A credit card sized digital storage device comprising;
a digital storage device;
a memory and processor for processing digital data;
an output on said card for converting and transmitting said digital data for audio and video output;
a set of touch sensitive controls on the planar surface of said card;
a modifiable planar surface for placement of graphics; and
a wireless transmitter for electrical access to said memory and processor for upload and download of said digital content.

9. A credit card sized digital storage device as claimed in claim 8 wherein said memory
stores patient's pertainent medical information for retrieval, addition and use by medical personnel.

10. A credit card sized digital storage device as claimed in claim 9 further comprising a USB for connection to a computing device.

11. A credit card sized digital storage device as claimed in claim 9 further comprising;
a biometric reader for secure access to patient's medical information when patient is unable to provide password for access.

12. A credit card sized digital storage device as claimed in claim 9 wherein said
graphics placed on said modifiable planar surface function as an identification card.

13. A credit card sized digital storage device as claimed in claim 9 further comprising
an emergency button on said planar surface for access to said medical information by medical personnel.

14. A method for managing medical information on a branded data storage device comprising the steps of:
Placing medical data content in data memory on a credit card sized handheld carrier capable of outputting said content in an audible and visual format;
Compiling medical content for a particular user for placement in said memory;
Branding the planar surface of said carrier with service provider related graphics; and
securing access to said digital content to prevent erasure of said content.

15. A method for managing medical information on a branded data storage device as claimed in claim 14 further comprising the step(s) of
allowing access to said digital content upon entry of a user defined password.

16. A method for managing medical information on a branded data storage device as claimed in claim 14 further comprising the step(s) of
allowing access to said digital content upon use of a biometric reader.
